(19) United States
(12) Patent Application Publication
(10) Pub. No.: US 2003/0194935 A1
(43) Pub. Date: Oct. 16, 2003

(54) Textile product for use in orthopedic technology

(76) Inventors: Jens Schlomski, Duderstadt (DE); Bernard Garus, Einbeck (DE); Jens Sprunk, Krumhermersdorf (DE)

Correspondence Address: HUSCH & EPPENBERGER, LLC, 401 MAIN STREET, SUITE 1400, PEORIA, IL, 61602, US

(21) Appl. No.: 10/412,449

(22) Filed: Apr. 11, 2003

(30) Foreign Application Priority Data
Apr. 12, 2002 (DE) 202 05 706.2

(51) Int. Cl. B32B 27/04; B32B 5/02; B32B 27/12

(52) U.S. Cl. 442/320; 442/149

(57) ABSTRACT

A textile product for use in orthopedic technology, such as for dressings, ligaments and in amputation stump care, including at least two layers of fabric, an outer-lying layer being made of a polyethylene fiber having high fiber orientation in a longitudinal direction, and an inner layer being made of a different fiber having a higher roughness than the outer-lying layer. A tubular orthopedic stump sock is made of this textile product.

### TECHNICAL FIELD OF THE INVENTION

The present invention relates generally to a textile product for use in orthopedic technology and, more particularly, to such a product for use in the area of upper and lower extremities, dressings, and kneecaps, and to textile materials for shaft comfort. The shaft comfort relates, inter alia, to stump socks.

Textiles used for orthopedic dressings, ligaments, cloths, liners and the like should have high tear and wear strength at high elasticity, wherein this should be associated with pleasant wearer comfort to the extent possible.

The textiles used in orthopedic technology are exposed to high, in particular mechanical loading. Therefore they wear out rapidly and become torn, fragile and rough. Because they are worn on the skin, the textiles are additionally stressed by heat influences, sweat, ointments and creams. These influences also cause the materials to become rough and fragile more rapidly.

Considerable roughness brings the disadvantage that wearer comfort is reduced, since clothing adheres to rough dressings or stump socks differently than to skin.

### SUMMARY OF THE INVENTION

An object of the invention is therefore to provide a textile that has a low surface resistance on its outer surface during wear and thus overall is relatively stable and wear-resistant.

The object is achieved by a textile product for use in orthopedic technology, in particular for dressings, ligaments and in amputation stump care, which has at least two woven or knitted layers, wherein at least one outer-lying layer in use consists of a polyethylene fiber having high fiber orientation in longitudinal direction and at least one further layer consists of a different fiber having higher roughness or the layers contain these fibers in each case.

The invention can preferably be used in orthopedic technology, in particular for the area of upper and lower extremities, dressings, and kneecaps and to textile materials for shaft comfort. The shaft comfort relates, inter alia, to stump socks. There is provided a tubular, orthopedic stump sock or liner, in which the textile product is provided additionally with an impact-damping pressure-equalizing coating, generally made from a polymer gel.

The textile product of the invention has very good surface properties, wherein a low surface resistance is associated with high stability and wear-resistance.

### DRAWINGS

(not applicable)

### DETAILED DESCRIPTION

Polyethylene fibers having high fiber orientation in longitudinal direction may be produced, for example from polyethylene having very high molecular weight, so-called “ultra high molecular weight polyethylene (UHMW-PE), of high crystallinity, wherein preferably parallel orientation of the fibers greater than 95% should be present. A fiber which can be obtained on the market under the tradename “Dyneema®” can be used very well. This fiber has a crystallinity of up to 85%, for parallel orientation of the fibers greater than 95%. The fiber has excellent resistance to water, seawater, moisture, most chemicals, UV light and microorganisms and is therefore already thus particularly suitable for use in orthopedic technology. The almost completely longitudinally orientated polyethylene fibers are particularly resistant to tearing and breaking. They are used, inter alia, for ropes and nets in shipping and bulletproof vests. Since they cannot be stretched, they are unsuitable in practice in this pure form for orthopedic articles. The polyethylene fibers described also cannot be dyed (color crude white), which further restricts their usability.

However, we have discovered that the fibers, processed to form knitted fabrics, can be processed and are suitable in excellent manner as a cover layer for orthopedic products, such as dressings, etc. In the at least a double-layer textile material embodying the invention, the smooth polyethylene fiber is joined to other fibers of higher roughness, as a result of which firstly, better wearer comfort and secondly, better coatability is achieved; for example with gel on the other fiber. To further increase the wearer comfort, additional fibers, for example natural fibers, which are capable of swelling and hence are sweat absorbing, may also be incorporated into the textile product. The layers of the textile product may be produced generally using all textile-producing techniques, such as knitting or weaving. The layers are preferably knitted.

In a preferred embodiment, the layers of the textile product are joined to one another, preferably looped together, at least at the edge. The layers may also be joined selectively in the surface. If a particularly firm bond is required, the layers may be adhered to one another, however it is preferable if at least one layer is plated onto another, and specifically the outer-lying polyethylene layer is preferably plated with cotton or polyester fibers. The term “plated” describes a knitted fabric made of two different yarns. As a result of plating, a textile knitted product is produced from two overlapping surfaces of different material.

A preferred exemplary embodiment is an overall or layer-wise circular-knitted textile, in which the individual layers may be joined as described above.

The tubular textile product thus obtained may be used as a dressing, for example knee or elbow dressing, or as a blank for a stump sock.

The fiber combination polyamide (PA), Lycra®, polyester (PES) and Dyneema® are particularly preferred. The additional use of cotton in the aforementioned fiber combination is also preferred.

The textile product is longitudinally resilient and transversely resilient and may be applied and fixed to orthopedic liners, inter alia, using special adhesive systems, as known as such. Alternatively, may also be coated without adhesion to the rougher fiber using polymer or gel material. The use of silicone gels, copolymer gels or polyurethane gels with the known adhesive systems is preferred.

A preferred exemplary embodiment of the invention is a tubular orthopedic stump sock closed on one side having outer-lying Dyneema fiber plating and inner-side silicone gel, copolymer gel or polyurethane gel coating. Such a product is also designated as a whole as a “liner”.

### EXAMPLES

The textile specifications for preferred exemplary embodiments are summarized in the following tables:

### Example 1

Stump sock textile Dyneema/cotton

Article: 22 601 021 01

Machine Data:

Small circular-knitting machine 256 needles,

Fineness 22E,

Cylinder diameter 3¾ inches.

TABLE 1
Material used:

| Material/thread guide | Rows Size 1 | Rows Size 2 | Rows Size 3 |
|---|---|---|---|
| 1 × Nylon 78f23/2 TWD | 10 | | |
| Color: beige 2053 | | | |
| 1 × Lycra 020.78/B Salzmann | 260 | | |
| Color: beige 88086 | | | |
| plated with 2 × Bw Nm 130/1 | | | |
| Color: crude white | | | |
| 1 × Lycra 020.78/B Salzmann | 534 | | |
| Color: beige 88086 | | | |
| plated with | | | |
| 1 × Dyneema 110dtex | | | |
| Color: crude | | | |
| 1 × Nylon 78f23/2 TWD | 10 | | |
| Color: beige | | | |
| Extension knitting | 30 | | |
| Horizontal dimension after | 11 cm | | |
| fixing | | | |

Material Composition:

| | | |
|---|---|---|
| Lycra 020.78/B | = | 49% |
| BW Nm 130/1 | = | 10% |
| Dyneema 110 dtex | = | 41% |

### Example 2

Stump sock textile Dyneema/polyester

Article: 22 600 021 02/03

Machine Data:

Small circular-knitting machine 256 needles,

Fineness 22E,

Cylinder diameter 3¾ inches.

TABLE 2
Material used:

| Material/thread guide | Rows Size 1 | Rows Size 2 | Rows Size 3 |
|---|---|---|---|
| 1 × Nylon 78f23/2 TWD | | 10 | 10 |
| Color: beige 2053 | | | |
| 1 × Lycra 020.78/B Salzmann | | 250 | 250 |
| Color: white | | | |
| plated with | | | |
| 2 × PES 76f24/1 TWD | | | |
| Color: beige 8404 | | | |
| 1 × Lycra 020.78/B Salzmann | | 470 | 440 |
| Color: white | | | |
| plated with | | | |
| 1 × PES 76f24/1 TWD | | | |
| Color: beige 8404 | | | |
| 1 × Dyneema 110 dtex | | | |
| Color: crude | | | |
| 1 × Nylon 78f23/2 TW | | 10 | 10 |
| Color: beige 2053 | | | |
| Extension knitting | | 37 cm | 42 cm |
| Horizontal dimension after | | 13 cm | 14 cm |
| fixing | | | |

Material Composition:

| | | |
|---|---|---|
| Lycra 020.78/B | = | 34% |
| PES 76f24/1 | = | 40% |
| Dyneema 110 dtex | = | 26% |

### Example 3

Stump sock textile Dyneema/polyester

Article: 22 600 021 01

Machine Data:

Small circular-knitting machine 256 needles,

Fineness 22E,

Cylinder diameter 3¾ inches.

TABLE 3
Material used:

| Material/thread guide | Rows Size 1 | Rows Size 2 | Rows Size 3 |
|---|---|---|---|
| 1 × Nylon 78f23/2 TWD | 10 | | |
| Color: beige 2053 | | | |
| 1 × Lycra 020.78/B Salzmann | 260 | | |
| Color: beige 88086 | | | |
| plated with | | | |
| 1 × PES 76f24/1 TWD | | | |
| Color: beige 8404 | | | |
| 1 × Lycra 020.78/B Salzmann | 534 | | |
| Color: beige 88086 | | | |
| plated with | | | |
| 1 × Dyneema 110 dtex | | | |
| Color: crude | | | |
| 1 × Nylon 78f23/2 TWD | 10 | | |
| Color: beige | | | |
| Extension knitting | 30 cm | | |
| Horizontal dimension after | 11 cm | | |
| fixing | | | |

Material Composition:

| | | |
|---|---|---|
| Lycra 020.78/B | = | 49% |
| PES 76f24/1 | = | 10% |
| Dyneema 110 dtex | = | 41% |

### Example 4

Stump sock textile Dyneema/cotton

Article: 22 601 021 02/03

Machine Data:

Small circular-knitting machine 256 needles,

Fineness 22E,

Cylinder diameter 3¾ inches.

TABLE 4
Material use:

| Material/thread guide | Rows Size 1 | Rows Size 2 | Rows Size 3 |
|---|---|---|---|
| 1 × Nylon 78f23/2 TWD | | 10 | 10 |
| Color: beige 2053 | | | |
| 1 × Lycra 020.78/B Salzmann | | 250 | 250 |
| Color: white | | | |
| plated with | | | |
| 1 × PES 76f24/1 TWD | | | |
| Color: beige 8404 | | | |
| 2 × Bw Nm 130/1 | | | |
| Color: crude white | | | |
| 1 × Lycra 020.78/B Salzmann | | | |
| Color: white | | | |
| plated with | | | |
| 1 × PES 76f24/1 TWD | | | |
| Color: beige 8404 | | | |
| 1 × Dyneema 110 dtex | | | |
| Color: crude | | | |
| 1 × Nylon 78f23/2 TWD | | 10 | 10 |
| Color: beige 2053 | | | |
| Extension knitting | | 37 cm | 42 cm |
| Horizontal dimension after | | 13 cm | 14 cm |
| fixing | | | |

Material Composition:

| | | |
|---|---|---|
| Lycra 020.78/B | = | 34% |
| PES 76f24/1 | = | 30% |
| BW Nm 130/1 | = | 10% |
| Dyneema 110 dtex | = | 26% |

The invention in its broader aspects is not limited to the specific examples shown and described but departures may be made therefrom within the scope of the accompanying claims without departing from the principles of the invention and without sacrificing its chief advantages.

What is claimed is:

1. A textile product for use in orthopedic technology, such as for dressings, ligaments and in amputation stump care, including at least two layers of fabric, an outer-lying layer being made of a polyethylene fiber having high fiber orientation in a longitudinal direction, and an inner layer being made of a different fiber having a higher roughness than the outer-lying layer.

2. A textile product according to claim 1, wherein the polyethylene fiber consists of UHMW-PE of high crystallinity and having substantially parallel fiber orientation.

3. A textile product according to claim 2, wherein the parallel fiber orientation is greater than 95%.

4. A textile product according to claim 1, wherein the layers are knitted.

5. A textile product according to claim 1, wherein the layers have edges which are joined to one another.

6. A textile product according to claim 1, wherein the layers are selectively joined.

7. A textile product according to claim 1, wherein the layers are adhered to one another.

8. A textile product according to claim 1, wherein at least one layer is plated onto the other layer.

9. A textile product according to claim 1, wherein at least one layer is circular-knitted.

10. A textile product according to claim 1, wherein at least one of the layers is coated on one side with a polymer.

11. A textile product according to claim 1, wherein at least one of the layers is coated on one side with a gel material.

12. A tubular orthopedic stump sock (liner) for amputation stump care including at least two layers of fabric, an outer-lying layer made of a polyethylene fiber having high fiber orientation in a longitudinal direction, and an inner layer made of a different fiber having a higher roughness factor than the outer-lying layer.

13. A tubular orthopedic stump sock according to claim 12, wherein the polyethylene fiber consists of UHMW-PE of high crystallinity and having essentially parallel fiber orientation.

14. A tubular orthopedic stump sock according to claim 13 wherein the parallel fiber orientation greater than 95%.

15. A tubular orthopedic stump sock according to claim 12, wherein the layers are knitted.

16. A tubular orthopedic stump sock according to claim 12, wherein the layers have edges which are joined to one another.
